(19) United States
(12) Patent Application Publication
(10) Pub. No.: US 2022/0252099 A1
(43) Pub. Date: Aug. 11, 2022

(54) FASTENERS

(71) Applicant: AFL Telecommunications LLC, Duncan, SC (US)

(72) Inventors: Steven Kranz, Moore, SC (US); Brent Sanders, Greenville, SC (US)

(21) Appl. No.: 17/174,012

(22) Filed: Feb. 11, 2021

(51) Int. Cl. F16B 23/00

(52) U.S. Cl. CPC F16B 23/0076

(57) ABSTRACT

A bolt including a torque section configured to self-release from a fastening tool upon reaching a threshold torque.

### FIELD

The present subject matter relates generally to fasteners, and more particularly to fasteners with torque sections configured to self-release from fastening tools.

### BACKGROUND

Fasteners are typically used when securing a plurality of elements together. One exemplary use for a fastener is when pressing two bores together axially. The fastener may be threaded and advance into the bores when torqued. Many applications require use of specific threshold torques. That is, an ideal torque to be applied to the fastener relative to the bore(s). Traditionally, this is accomplished through the use of a torque wrench which can be set to the specific threshold torque requirement for each fastener.

Several industries rely on precise and accurate application of threshold torques. These industries include, for example, the fiber optic industry. In the power utility industry, it is common to require threshold torques when working with wedge connectors, stockbridge dampers, bolted deadends, and the like. However, it is not always practical to use a torque wrench and shear-head bolts leave behind a sheared-off portion or require the installation technician to collect the sheared-off portions. Thus, these industries continue to demand improvements to fasteners for use with threshold torques that do not waste material and increase installation/assembly time.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a fastener in accordance with an exemplary embodiment of the present disclosure as seen prior to being torqued to a threshold torque.

FIG. 2 is a cross-sectional top view of the fastener of FIG. 1 as seen along Line A-A in accordance with an exemplary embodiment of the present disclosure.

FIG. 3 is a perspective view of the fastener of FIG. 1 in accordance with an exemplary embodiment of the present disclosure as seen after being torqued to the threshold torque.

FIG. 4 is a cross-sectional top view of the fastener of FIG. 1 as seen along Line B-B in accordance with an exemplary embodiment of the present disclosure.

FIG. 5 is a cross-sectional view of a fastener with one or more fastening tools disposed in engagement therewith in accordance with an exemplary embodiment of the present disclosure.

FIG. 6 is a chart illustrating a plot of torque transfer and deformation of a torque element of a fastener in accordance with an exemplary embodiment of the present disclosure.

FIG. 7 is a perspective view of a fastener in accordance with another exemplary embodiment of the present disclosure as seen prior to being torqued to a threshold torque.

FIG. 8 is a perspective view of the fastener of FIG. 7 in accordance with an exemplary embodiment of the present disclosure as seen after being torqued to the threshold torque.

FIG. 9 is a perspective view of a fastener in accordance with another exemplary embodiment of the present disclosure as seen prior to being torqued to a threshold torque.

FIG. 10 is a perspective view of the fastener of FIG. 9 in accordance with an exemplary embodiment of the present disclosure as seen after being torqued to the threshold torque.

FIG. 11 is a chart illustrating a plot of torque transfer and deformation of a torque element of a fastener in accordance with an exemplary embodiment of the present disclosure.

FIG. 12 is a top view of a fastening tool and a fastener undergoing elastic deformation in accordance with another exemplary embodiment.

### DETAILED DESCRIPTION

Reference now will be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, fasteners described in accordance with one or more embodiments of the present disclosure can be configured to self-release from a fastening tool upon reaching a desired threshold torque. As used herein, “threshold torque” refers to the specific torque prescribed for a particular fastener and/or application. Whereas threshold torque is traditionally controlled through the use of a torque wrench, embodiments of the present disclosure describe a fastener which can self-release from a fastening tool upon receiving a threshold torque. As used herein, “self-release” refers to a change in characteristics that are substantially, or even entirely, intrinsic to the fastener and which cause the fastener to disengage from the fastening tool, allowing the fastening tool to slip at the threshold torque. These intrinsic characteristics may include, for example, material selection (e.g., material density, Shore A hardness, ductility, etc), physical design (e.g., size, shape, engineered features such as crush areas or bend reliefs, etc), or the like.

Referring to FIG. 1, a fastener 100 can generally include a shank 102, a head 104, and a torque element 106. The shank 102 can extend from a bottom surface 108 of the head 104. In the illustrated embodiment, the head 104 is disposed between the shank 102 and the torque element 106. In certain applications, the bottom surface 108 of the head 104 can come into contact with a surface of an object being fastened to another element. In other applications, the bottom surface 108 of the head 104 can be spaced apart from the surface of the object by one or more washers, O-rings, lock washers, or the like. While not depicted, the shank 102 can have an engagement element such as a threaded, or partially threaded, face, or another suitable engagement element to capture a nut or the like for fastening operations.

Referring to FIG. 2, the head 104 of the fastener 100 can have a first cross-sectional shape, as seen from a top view. In an embodiment, the head 104 can have a generally polygonal shape, such as a hex head suitable for being operated upon by a tool, such as a wrench, e.g., an open-ended wrench, a box-end wrench, a combination wrench, a ratcheting wrench, a socket wrench, a spanner wrench, a crescent wrench, a pipe wrench, an alligator wrench, a lug wrench, a socket wrench, or an impact wrench. Other polygonal shapes may be suitable for the cross-sectional shape of the head 104. These other polygonal shapes include triangles, squares, pentagons, and the like. The polygonal shapes can be equilateral, equiangular, neither, or both. In another embodiment, the head 104 can have an arcuate or otherwise non-polygonal shape. The type, size, and geometry of the tool or tool head used may vary based on the particular attributes, e.g., geometry, of the head 104.

The torque element 106 depicted in FIGS. 1 and 2 defines a second cross-sectional shape, as seen from the top view. The torque element 106 can have a generally polygonal shape, such as a hex head suitable for being operated upon by a tool, such as a wrench. Other polygonal shapes may also be suitable for the cross-sectional shape of the torque element 106. These other polygonal shapes can include triangles, squares, pentagons, and the like. The polygonal shapes can be equilateral, equiangular, neither or both. In another embodiment, the torque element 106 can have an arcuate or otherwise non-polygonal shape. The type, size, and geometry of the tool or tool head used may vary based on the particular attributes, e.g., geometry, of the torque element 106.

In certain instances, the first and second cross-sectional shapes can be different from one another. That is, the head 104 and torque element 106 can have different cross-sectional shapes as compared to one another. In another embodiment, the head 104 and torque element 106 can have the same cross-sectional shapes or similar cross-sectional shapes as one another.

In an embodiment, the head 104 can define a first effective diameter, D₁, different from a second effective diameter, D₂, of the torque element 106. For instance, D₁ can be greater than D₂. In a more particular embodiment, D₁ can be greater than D₂ at least after the fastening tool (described in greater detail below) slips relative to the torque element 106. By way of example, D₁ can be at least 101% D₂, such as at least 105% D₂, such as at least 110% D₂, such as at least 125% D₂, such as at least 150% D₂, such as at least 175% D₂, such as at least 200% D₂. In an embodiment, D₁ can be less than 1000% D₂, such as less than 500% D₂, such as less than 250% D₂. It should be understood that the first and second effective diameters, D₁ and D₂, depicted in FIG. 2 are exemplary in depiction and may instead be measured using an alternative method or system. In certain instances, the use of different effective diameters D₁ and D₂ may permit an operator to install a fastening tool over the torque element 106 when engaging the head 104. That is, by having a smaller D₂, the fastening tool may more easily pass by the torque element 106 to reach the head 104.

The torque element 106 depicted in FIG. 2 is a three-sided body. The three-sided body defines apexes 110 where sidewalls of the three-sided body meet. In particular, the illustrated three-sided body defines three apexes 110. These apexes 110, or at least one of these apexes 110, can define a first shape prior to a torqueing event. That is, prior to use, at least one of the apexes 110 can define a first shape. In the illustrated embodiment, the first shape includes sharp apexes 110 formed by junctions between two linear sidewall surfaces of the torque element 106.

Referring to FIG. 5, a fastening tool 112 can be installed relative to the torque element 106 so as to engage at least the apexes 110. More particularly, an inner surface 114 of the fastening tool 112 can engage with at least one of the apexes 110 to permit transfer of torque from the fastening tool 112 to the fastener 100. Use of the fastening tool 112 can be performed by aligning the fastening tool 112 with the torque element 106, applying torque to the torque element 106 using the fastening tool 112, and removing the fastening tool 112 from the torque element 106 after the fastening tool 112 slips relative to the torque element 106.

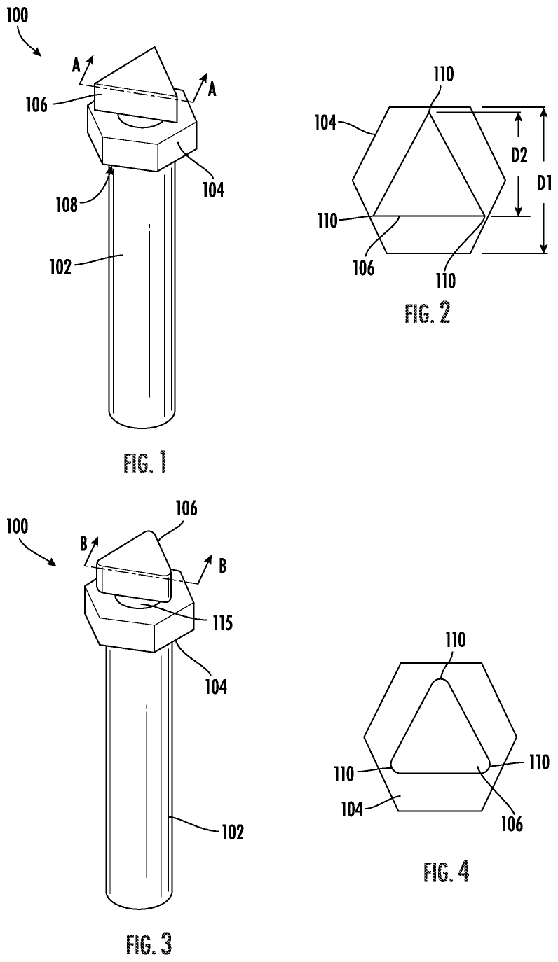

FIGS. 3 and 4 illustrates views of the exemplary fastener 100 described with respect to FIGS. 1 and 2 after the above-described method of using the fastening tool 112 to torque the fastener 100 is performed. In the illustrated embodiment, the apexes 110 of the torque element 106 are deformed to a second shape different than the aforementioned first shape described with respect to FIGS. 1 and 2 as a result of torque application. Deformation between the first and second shapes can occur as a result of intrinsic characteristics of the fastener 100, and more particularly intrinsic characteristics of the torque element 106 or another torque limiting component of the fastener 100, e.g., a portion of shaft 115 disposed between the torque element 106 and the head 104. Upon deforming, the second effective diameter, D₂, of the torque element 106 can decrease to D_{2SLIP}, whereupon the torque element 106 can slip relative to the fastening tool 112. That is, the inner surface 114 of the fastening tool 112 may rotate freely, or substantially freely so as to not transfer torque above the threshold torque value, with respect to the torque element 106. In such a manner, application of torque from the fastening tool 112 to the fastener 100 can be applied up to the threshold torque value without exceeding the threshold torque. Moreover, application of threshold torque can be performed without use of any special tools (e.g., torque wrenches) and without leaving behind any sheared-off sections of fastener 100 typical of shear-bolts. Upon reaching the threshold torque value, the torque element 106 is sufficiently deformed so as to permit slipping between the torque element 106 and the fastening tool 112. While slipping between the torque element 106 and fastening tool 112 may occur upon reaching the threshold torque as a result of deformation of the torque element 106, deformation of the torque element 106 may begin prior to reaching the threshold torque. That is, deformation may occur over a range of applied torque up to the threshold torque.

In an embodiment, the torque element 106 can undergo plastic deformation in route to reaching the threshold torque. Deformation shown in FIG. 4 is in a radial direction and generally includes flattening in the radial direction. However, as described below with other embodiments, deformation can also, or alternatively, include circumferential deformation and other types of deformation which change the shape of the torque element 106.

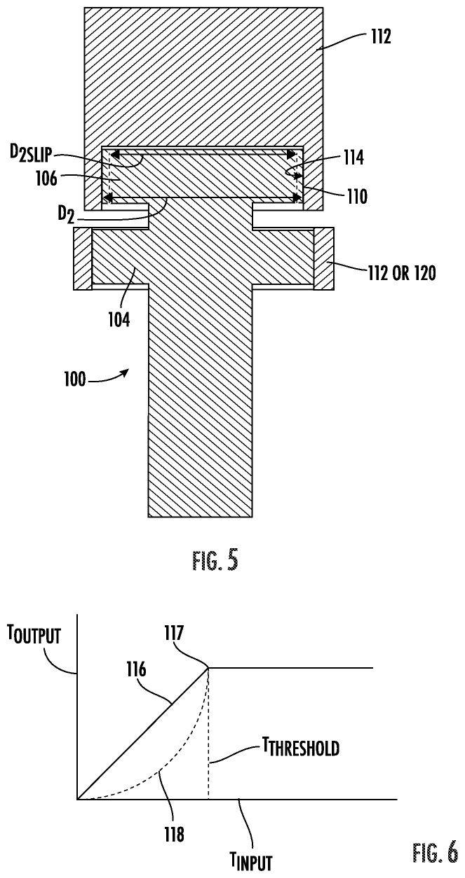

FIG. 6 illustrates a plot 116 showing an exemplary torque transfer between the fastening tool 112 and the fastener 100 under increasing torque loads. As torque input, T_{INPUT}, from the fastening tool 112 increases, torque output, T_{OUTPUT}, to the fastener 100 increases until reaching the threshold torque, T_{THRESHOLD}. Upon reaching T_{THRESHOLD}, torque transfer ceases regardless of torque input. While the inflection 117 is depicted as a sharp angle, in certain instances the inflection 117 can be rounded or have a fillet in response to the selected intrinsic characteristics of the torque element 106. In yet other instances, the inflection 117 can include a variable inflection, e.g., a multi-planar inflection including a series of gradually reducing straight line segments (this may be caused, e.g., by secondary surfaces or embedded materials which provide secondary torque thresholds). These variable inflections may be experienced by the operator applying torque as indication of reaching the inflection 117. This indication may be experienced as a tactile, audible, or visual indicator of reaching the threshold torque. For instance, the torque element 106 may generate a click, an initial slip followed by a secondary slip, a color change, or another suitable indicator.

FIG. 6 further illustrates an exemplary plot 118 of deformation of the torque element 106 under torque application. At T_{THRESHOLD} deformation of the torque element 106 reaches a critical amount at which slip can occur between the fastening tool 112 and the torque element 106, thereby substantially preventing further deformation after T_{THRESHOLD} is reached.

It should be understood that use of the fastening tool 112 on the torque element 106 is particularly suitable for tightening the fastener 100 to a prescribed threshold torque. However, it may be desirable to utilize the head 104 to loosen and remove the fastener 100 as the torque element 106 is deformed during the tightening phase of use. In this regard, the head 104 may be configured to receive torque from the aforementioned fastening tool 112 or another tool 120. In an embodiment, the same fastening tool 112 can be used to apply torque to the torque element 106 and the head 104. In another embodiment, the other tool 120 can be used to apply torque, e.g., loosening torque, to the head 104. Because loosening fasteners generally does not need to be performed at a prescribed torque, the head 104 may be nondeformable, or only nominally deformable, when torqued by the fastening tool 112 or another tool 120.

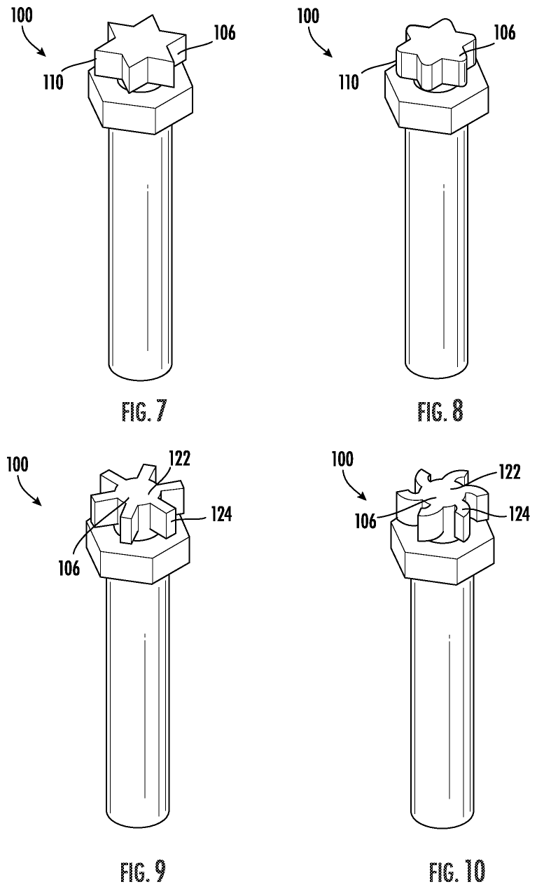

FIGS. 7 and 8 illustrate an embodiment of the fastener 100 in accordance with another embodiment. The fastener 100 depicted in FIGS. 7 and 8 operates similar to that previously described, however, unlike the embodiment depicted in FIGS. 1-4, the torque element 106 of the embodiment depicted in FIGS. 7 and 8 has a star-shaped cross-sectional shape. The apexes 110 of the star-shaped cross-sectional shape can deform by flattening in a radially inward direction. The apexes 110 may further deflect in a circumferential direction, similar to that as described below with respect to FIGS. 9 and 10.

Referring to FIGS. 9 and 10, the fastener 100 may include a torque element 106 having a feature configured to deform primarily through circumferential deflection. For instance, the fastener 100 depicted in FIGS. 9 and 10 includes a hub 122 and a plurality of members 124 extending radially outward from the hub 122. At least one of the members 124 can be configured to deform when the fastener 100 is torqued to the torque threshold. Thus, the hub 122 and members 124 can act in a manner similar to that of the aforementioned apexes 110. That is, deflection of the members 124 can reduce the effective second diameter, D₂, of the torque element 106, permitting relative slip between the torque element 106 and the fastening tool 112 upon reaching the threshold torque. Intrinsic characteristics of the hub 122 and members 124 which may affect the threshold torque include material selection (e.g., material density, Shore A hardness, ductility, etc), physical design (e.g., size, shape, engineered features such as crush areas or bend reliefs, etc), or the like.

In an embodiment, at least a portion of the fastener 100 can be configured to exhibit elastic deformation, or substantially elastic deformation. For example, one or more of the members 124 and/or the hub 122 can be configured to deform through elastic deformation until the threshold torque is reached. Upon reaching threshold torque, elastic deformation can permit relative slip between the torque element 106 and the fastening tool 112. In certain instances, the elastically deformed portion of the fastener 100 can return to its original, i.e., previously undeformed state, or substantially original, condition. Through shape selection and material design, the threshold torque may be reached in either or both a clockwise direction and a counter-clockwise direction. In certain instances, the threshold torques will be the same in both directions. In other instances, the threshold torques in each direction may be different from one another.

In yet another embodiment, the fastener 100 may initially have the shape illustrated in FIG. 10 until application of torque by the fastening tool 112 which causes the fastener 100 to take the shape illustrated in FIG. 9. That is, the threshold torque can deform the members and/or hub 122 from the shape shown in FIG. 10 to the shape shown in FIG. 9.

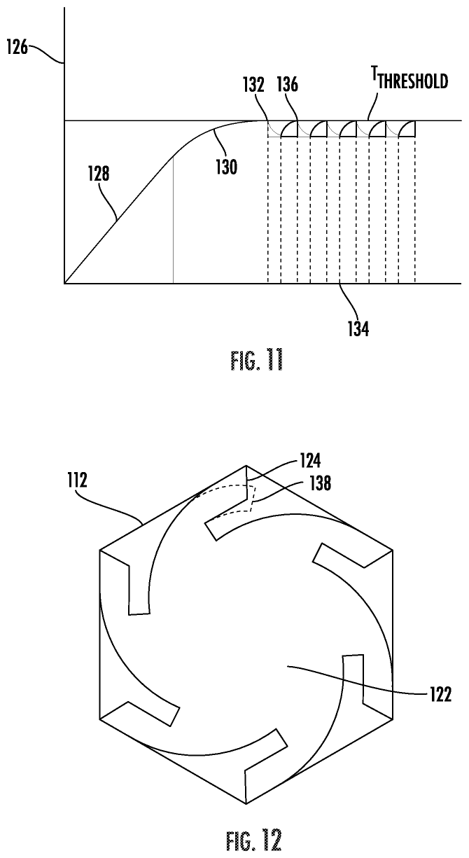

In an embodiment the torque element 106 can be configured to operate repeatedly over a plurality of torquing events. That is, the process of deforming the members and/or hub 122 upon reaching threshold torque can be repeatable. In this regard, the same fastener 100 can be used a plurality of times, such as at least twice, such as at least three times, such as at least four times, such as at least ten times, such as at least twenty times, such as at least fifty times, such as at least one hundred times. Referring to FIG. 11, an exemplary plot 126 is depicted showing deformation 128 of a repeatably torque-ready torque element 106. Deformation begins at an initial deformation point and occurs over a period 130 until reaching threshold torque 132, whereby slip can occur between the fastening tool 112 and the torque element 106, thereby substantially preventing further deformation after T_{THRESHOLD} is reached. However, unlike the chart depicted in FIG. 6, the torque element 106 can at least partially spring back to a non-deformed state 134. That is, for instance, the deformation described above can be elastic, or partially elastic. In such a manner, the torque element 106 can rebound from a maximum deformation state which occurs at T_{THRESHOLD} to its less deformed (i.e., more original) shape. The percentage of rebound from maximum deformation state (i.e., the elasticity of the torque element 106) can be at least 1% of maximum deformation, such as at least 2% of maximum deformation, such as at least 3% of maximum deformation, such as at least 4% of maximum deformation, such as at least 5% of maximum deformation, such as at least 10% of maximum deformation, such as at least 15% of maximum deformation. The rebound may return the torque element 106 closer to the original shape.

The fastener 100 can be reused after the first instance of reaching threshold torque 132. This is shown by a second upward slope terminating at a second threshold torque 136. The second threshold torque 136 can be the same, or generally the same, as the threshold torque 132 from the first instance of reaching threshold torque 132. This reuse of the fastener 100 can occur a plurality of times. In the exemplary chart shown in FIG. 11, the fastener undergoes six loading cycles to threshold torque. The fastener may be used for more or less loading cycles as needed.

Elastic deformation of the torque element 106 may occur as a result of material selection (e.g., a substrate or one or more fillers), physical shape of the torque element 106, use of biasing elements like springs, or any combination thereof. For instance, FIG. 12 illustrates a top view of the fastener 100 with the torque element 106 including members 124 and the hub 122. The members 124, or at least some of the members 124, can be deformable to a position as shown by line 138. At this deflected position, the fastening tool 112 can slip relative to the torque element 106, permitting application of threshold torque. The members 124 can then rebound to permit a secondary torquing.

In an embodiment, the aforementioned fastener 100 may be part of a set of fasteners including at least 100 fasteners, such as at least 1,000 fasteners, such as at least 10,000 fasteners each defining an actual threshold torque, i.e., the actual torque value at which intrinsic characteristics of each of the fasteners slip relative to the fastening tool 112, within a threshold deviating from a desired (rated) threshold torque by less than ±50 Nm, such as less than ±40 Nm, such as less than ±30 Nm, such as less than ±20 Nm, such as less than ±10 Nm, such as less than ±5 Nm, such as less than ±1 Nm, such as less than ±0.1 Nm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by one or more of the following embodiments:

Embodiment 1. A fastener comprising: a shank; and a torque element, wherein the torque element is configured to transmit torque to the shank, wherein the torque element is configured to slip relative to a fastening tool upon reaching a torque threshold, and wherein the torque element is configured to remain attached to the shank after slipping relative to the fastening tool.

Embodiment 2. The fastener of any one or more of the embodiments, wherein the fastener further comprises a head disposed between the shank and the torque element, wherein the head has a first effective diameter, D₁, wherein the torque element has a second effective diameter, D₂, and wherein D₁ is no less than D₂ at least after the fastening tool slips relative to the torque element.

Embodiment 3. The fastener of any one or more of the embodiments, wherein the head has a first cross-sectional shape, as seen along an axial direction of the shank, wherein the torque element has a second cross-sectional shape, as seen along the axial direction, and wherein the first and second cross-sectional shapes are different from one another.

Embodiment 4. The fastener of any one or more of the embodiments, wherein the head is disposed between the torque element and the shank, and wherein the shank extends from a bottom surface of the head.

Embodiment 5. The fastener of any one or more of the embodiments, wherein the torque element is configured to deform when the fastener is torqued to the torque threshold.

Embodiment 6. The fastener of any one or more of the embodiments, wherein deformation of the torque element comprises bending in a circumferential direction, flattening in a radial direction, or a combination thereof.

Embodiment 7. The fastener of any one or more of the embodiments, wherein deformation of the torque element comprises plastic deformation.

Embodiment 8. The fastener of any one or more of the embodiments, wherein the torque element comprises a hub and a plurality of members extending radially outward from the hub, and wherein at least one of the members is configured to deform when the fastener is torqued to the torque threshold.

Embodiment 9. The fastener of any one or more of the embodiments, wherein deformation of the torque element comprises elastic deformation.

Embodiment 10. A bolt comprising a torque section configured to self-release from a fastening tool upon reaching a threshold torque.

Embodiment 11. The bolt of any one or more of the embodiments, wherein the fastening tool comprises a hex wrench.

Embodiment 12. The bolt of any one or more of the embodiments, wherein the torque section is configured to remain attached to the bolt after self-releasing from the fastening tool.

Embodiment 13. The bolt of any one or more of the embodiments, wherein self-release is configured to occur as a result of plastic or elastic deformation of the torque section.

Embodiment 14. The bolt of any one or more of the embodiments, wherein the bolt is part of a set of bolts, the set of bolts including at least 100 bolts, and wherein the threshold torque of each of the at least 100 bolts deviates from a rated threshold torque by less than ±50 Nm.

Embodiment 15. A method of torqueing a fastener, the method comprising: aligning a fastening tool with a torque element of the fastener; applying torque to the torque element using the fastening tool; and removing the fastening tool from the torque element after the fastening tool slips relative to the torque element.

Embodiment 16. The method of any one or more of the embodiments, further comprising: aligning the fastening tool or another tool with a head of the fastener, the head of the fastener being different from the torque element; and applying a loosening torque force to the head.

Embodiment 17. The method of any one or more of the embodiments, wherein the head has a first effective diameter, D₁, wherein the torque element has a second effective diameter, D₂, and wherein D₁ is greater than D₂ at least after the fastening tool slips relative to the torque element.

Embodiment 18. The method of any one or more of the embodiments, wherein applying torque to the torque element is performed by increasing torque applied by the fastening tool until a torque threshold is reached, the torque threshold being defined by the fastener.

Embodiment 19. The method of any one or more of the embodiments, wherein the steps of applying torque and removing the fastening tool are performed without removing the torque element from the fastener.

Embodiment 20. The method of any one or more of the embodiments, wherein applying torque to the torque element is performed such that the torque element plastically deforms, and wherein the deformation comprises at least one of bending in a circumferential direction or flattening in a radial direction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fastener comprising:
a shank; and
a torque element,
wherein the torque element is configured to transmit torque to the shank, wherein the torque element is configured to slip relative to a fastening tool upon reaching a torque threshold, and wherein the torque element is configured to remain attached to the shank after slipping relative to the fastening tool.

2. The fastener of claim 1, wherein the fastener further comprises a head disposed between the shank and the torque element, wherein the head has a first effective diameter, D₁, wherein the torque element has a second effective diameter, D₂, and wherein D₁ is no less than D₂ at least after the fastening tool slips relative to the torque element.

3. The fastener of claim 2, wherein the head has a first cross-sectional shape, as seen along an axial direction of the shank, wherein the torque element has a second cross-sectional shape, as seen along the axial direction, and wherein the first and second cross-sectional shapes are different from one another.

4. The fastener of claim 2, wherein the head is disposed between the torque element and the shank, and wherein the shank extends from a bottom surface of the head.

5. The fastener of claim 1, wherein the torque element is configured to deform when the fastener is torqued to the torque threshold.

6. The fastener of claim 5, wherein deformation of the torque element comprises bending in a circumferential direction, flattening in a radial direction, or a combination thereof.

7. The fastener of claim 5, wherein deformation of the torque element comprises plastic deformation.

8. The fastener of claim 1, wherein the torque element comprises a hub and a plurality of members extending radially outward from the hub, and wherein at least one of the members is configured to deform when the fastener is torqued to the torque threshold.

9. The fastener of claim 1, wherein deformation of the torque element comprises elastic deformation.

10. A bolt comprising a torque section configured to self-release from a fastening tool upon reaching a threshold torque.

11. The bolt of claim 10, wherein the fastening tool comprises a hex wrench.

12. The bolt of claim 10, wherein the torque section is configured to remain attached to the bolt after self-releasing from the fastening tool.

13. The bolt of claim 10, wherein self-release is configured to occur as a result of plastic or elastic deformation of the torque section.

14. The bolt of claim 10, wherein the bolt is part of a set of bolts, the set of bolts including at least 100 bolts, and wherein the threshold torque of each of the at least 100 bolts deviates from a rated threshold torque by less than ±50 Nm.

15. A method of torqueing a fastener, the method comprising:
aligning a fastening tool with a torque element of the fastener;
applying torque to the torque element using the fastening tool; and
removing the fastening tool from the torque element after the fastening tool slips relative to the torque element.

16. The method of claim 15, further comprising:
aligning the fastening tool or another tool with a head of the fastener, the head of the fastener being different from the torque element; and
applying a loosening torque force to the head.

17. The method of claim 16, wherein the head has a first effective diameter, D₁, wherein the torque element has a second effective diameter, D₂, and wherein D₁ is greater than D₂ at least after the fastening tool slips relative to the torque element.

18. The method of claim 15, wherein applying torque to the torque element is performed by increasing torque applied by the fastening tool until a torque threshold is reached, the torque threshold being defined by the fastener.

19. The method of claim 15, wherein the steps of applying torque and removing the fastening tool are performed without removing the torque element from the fastener.

20. The method of claim 15, wherein applying torque to the torque element is performed such that the torque element plastically deforms, and wherein the deformation comprises at least one of bending in a circumferential direction or flattening in a radial direction.
